(19) United States
(12) Patent Application Publication
(10) Pub. No.: US 2015/0292105 A1
(43) Pub. Date: Oct. 15, 2015

(54) COMPOSITES OF CARBON BLACK AND METAL

(71) Applicant: Rohm and Haas Electronic Materials LLC, Marlborough, MA (US)

(72) Inventors: Wan Zhang-Beglinger, Lucerne (CH); Linda Stappers, Tienen (BE); Jan Fransaer, Leefdaal (BE); Michael P. Toben, Marlborough, MA (US)

(21) Appl. No.: 14/748,599

(22) Filed: Jun. 24, 2015

Related U.S. Application Data
(62) Division of application No. 13/784,009, filed on Mar. 4, 2013.
(60) Provisional application No. 61/606,170, filed on Mar. 2, 2012.

(51) Int. Cl. C25D 15/00; H01B 1/02

(52) U.S. Cl. CPC C25D 15/00; H01B 1/02

(57) ABSTRACT

Nano-sized particles of carbon black and various metal ions are mixed to form substantially homogenous solutions or dispersions. The nano-sized particles of carbon black and metal ions are electroplated on various types of substrates as composites of one or more metals and substantially uniformly dispersed nano-sized particles of carbon black within the metals.

This application claims the benefit of priority under 35 U.S.C. §119(e) to U.S. Provisional Application No. 61/606,170, filed Mar. 2, 2012, the entire contents of which application are incorporated herein by reference.

### FIELD OF THE INVENTION

The present invention is directed to composites of carbon black particles and metal. More specifically, the present invention is directed to composites of carbon black particles and metal where the carbon black particles are in the nanometer range.

### BACKGROUND OF THE INVENTION

Composite plating is a technology well documented and widely practiced in both electrolytic and electroless plating. Composite plating refers to the inclusion of particulate matter within a metal plated layer. The development and acceptance of composite plating stems from the discovery that the inclusion of particles within a metal plated layer can enhance various properties of the metal plated layer and in many situations actually provide entirely new properties to the metal layer. Particles of various materials can provide characteristics to the metal layer including wear resistance, lubricity, corrosion resistance, phosphorescence, friction altered appearances and other properties.

For some time the most common composites used for increasing durability of articles were those deposited from electroless nickel plating baths which included particles of diamond and polytetrafluoroethylene (PTFE). Over the years the variety of metals and fine particles has increased to produce a wide range of different composites. JP09-007445 discloses a sliding contact electric component which has an electroplated coating film of graphite particles dispersed in a silver metal matrix. In addition to graphite, particles of SiC, WC, ZrB, Al₂O₃, ZrO₂ and Cr₂O₃ may also be incorporated into the composite. Also, particles of TiO₂, ThO₂, MoO₃, W₂C, TiC, B₄C and CrB₂ may be included to increase the hardness of the deposited coating.

U.S. Pat. No. 6,635,166 discloses an electrolytic composite plating method. In addition to fine particles of diamond and PTFE, the patent discloses particles of SiC, glass, kaolin, corundum, Si₃N₄, various metal oxides, graphite, graphite fluoride, various colorants and other metal compounds such as compounds of W, Mo and Ti. Metals which may be electroplated with such particles include, for example, silver, gold, nickel, copper, zinc, tin, lead, chromium and alloys thereof. To achieve the desired properties mentioned above, azo-surfactants are included in the composite plating formulations to enable an increase in the content of the particles in the electroplating bath.

U.S. Pat. No. 7,514,022 discloses a composite of silver and graphite particles used to electroplate a coating on switches and connectors. The graphite particles range in size from 0.1 μm to 1.0 μm. Additives such as dispersing agents are excluded from the formulation. Although including dispersing agents or surfactants in composite plating baths may increase the content of fine particles to some extent, the dispersing agent effect is known to be limited. It is believed that the dispersing agent or surfactant remains as it is on the fine particles which have been deposited by electroplating in the adsorbed state. This is believed to inhibit other fine particles from being deposited. Instead the graphite particles are oxidized to achieve the desired dispersion of particles in the silver electroplating baths. Such oxidizing agents include nitric acid, hydrogen peroxide, potassium permanganate, potassium persulfate, sodium persulfate and sodium perchlorate.

In addition to achieving as high a concentration of fine particles as possible in the electroplating bath, it is also desirable to use particles with sufficient electrical conductivity and as small a diameter as possible. This is important to ensure electrical continuity between the plated mating surfaces of an electronic connector. However, the smaller the particle the more readily it is to agglomerate with other particles in the plating bath causing the particles to rapidly settle to the bottom of the plating vessel thus making them unavailable for codeposition. Therefore codepositing all particles in a metal plating bath which have diameters in the nanometer range has been challenging. Accordingly, there is a need for a composite of nano-particles and metal where the nano-particles have sufficient electrical conductivity and at the same time do not readily agglomerate in the metal electroplating bath.

### SUMMARY OF THE INVENTION

In one aspect compositions include one or more sources of metal ions and carbon black nano-particles.

In another aspect methods include providing a composition including one or more sources of metal ions and carbon black nano-particles; contacting a substrate with the composition; and electroplating a composite of one or more metals and carbon black nano-particles onto the substrate.

In an additional aspect articles include a composite including one or more metals and carbon black nano-particles dispersed within the one or more metals.

The compositions are substantially stable dispersions of carbon black nano-particles and metal ions which can he electroplated on various substrates to form coatings of composites of metal or metal alloy having substantially uniform dispersions of the carbon black nano-particles throughout a metal or metal alloy matrix. The composites are electrically conductive and provide good wear resistance with improved durability in comparison to many conventional metal and metal alloy coatings. The composite coatings may be used to replace hard gold coatings of gold/cobalt and gold/nickel which are often used to coat articles which are exposed to rigorous wear cycles or arc prone to oxidation due to heat in sliding processes, such as is typical in switches and connectors.

### BRIEF DESCRIPTION OF THE DRAWINGS

FIG. 1 is a SEM at 3500× of a cross-section of a composite of silver and graphite particles.

FIG. 2 is a SEM at 5000× of a cross-section of a composite of silver and carbon black nano-particles.

FIG. 3 is a graph of contact resistance in mOhm versus contact forces in cN of a silver and silver and carbon black nanoparticles.

FIG. 4 is a SEM at 10,000× of a cross section of a composite of silver and carbon black nano-particles.

### DETAILED DESCRIPTION OF THE INVENTION

As used throughout this specification, the terms “depositing”, “plating” and “electroplating” are used interchangeably, and the terms “composition” and “bath” are used interchangeably. The indefinite articles “a” and “an” are intended to include both the singular and the plural.

The following abbreviations have the following meanings unless the context clearly indicates otherwise: ° C.=degrees Celsius; g=grams; ml=milliliter; L=liter; cm=centimeters; A=amperes; dm=decimeter; ASD=A/dm²; μm=microns; nm=nanometers; mmol=millimoles; mOhm=milliohms; cN=centiNewtons; SEM=scanning electron micrograph; and EO/PO=ethylene oxide/propylene oxide. All percentages and ratios are by weight unless otherwise indicated. All ranges are inclusive and combinable in any order except where it is logical that such numerical ranges are constrained to add up to 100%.

Compositions are aqueous dispersions of carbon black nano-particles and one or more sources of metal ions. Carbon black is an amorphous form of carbon with a high surface area to volume ratio and is electrically conductive. In contrast to carbon black, diamond and graphite are crystalline in structure. Diamond has a tetrahedral configuration. Graphite has a layered, planar crystal structure where each carbon atom is bonded to three other carbons forming a hexagonal structure. Graphite is much softer than diamond and the layered, planar type structure facilitates easy cleavage along the planes which makes it desirable as a solid lubricant but is not very durable in coatings which are exposed to rigorous wear cycles. In general, it has a relatively low coefficient of friction.

Carbon black nano-particles have an average diameter range from 5 nm to 500 nm, preferably from 10 nm to 250 nm, more preferably from 15 nm to 100 nm and most preferably from 15 nm to 30 nm. The carbon black nano-particles are spherical or elliptical in shape, not fibers or nano-tubes. Carbon black may he obtained from various commercial sources or prepared by one or more conventional methods known in the art. Carbon black may he produced industrially, for example, by the incomplete combustion of heavy petroleum products such as coal tar and ethylene cracking tar. A commercially available source of carbon black is Degussa® Carbon Black (available from Orion Engineered Carbons, Germany). Typically, the commercially available carbon black is agglomerated and is not within the desired particle size range. Accordingly, to achieve the desired particle size range the agglomerated carbon black particles may be dc-agglomerated using ultrasonic methods and apparatus well known in the art.

The carbon black nano-particles may be added to an aqueous solution of one or more water-soluble metal salts which may include one or more surfactants and conventional additives found in metal plating baths. In general, the surfactants are added to the water first then the carbon black nano-particles are added and this mixture is added to the plating bath. The carbon black nano-particles may also be mixed in commercially available metal electroplating baths. The components of the bath are typically mixed using high power ultrasonic laboratory mixing apparatus to achieve a substantially uniform dispersion of carbon black nano-particles and plating bath components. Carbon black nano-particles are included in the metal electroplating baths in amounts of at least 1 g/L, preferably at least 10 g/L, more preferably from 20 g/l to 200 g/l, most preferably from 50 g/L to 150 g/L.

Metals which may be co-deposited with the carbon black nano-particles are provided by one or more sources of water-soluble metal salts. Although silver is the most preferred metal for forming the composite with the carbon black nano-particles, it is envisioned that other metals and metal alloys may be used to form the composites. Water-soluble metal salts which provide metal ions for the deposition of metals include, but are not limited to, silver, gold, palladium, tin, indium, copper and nickel. Such water-soluble metal salts are generally commercially available from a variety of suppliers or may be prepared by methods well known in the art. It is envisioned that alloys of such metals may also be co-deposited with the carbon black nano-particles. Such alloys may include, but are not limited to, tin/silver, tin/copper, palladium/nickel and tin/silver/copper. Preferably the metal co-deposited with the carbon black nano-particles is silver, gold, palladium, tin or palladium/nickel alloy. More preferably the metal co-deposited with the carbon black nano-particles is silver or tin. Most preferably the metal co-deposited with the carbon black nano-particles is silver. In general, one or more sources of metal ions are included in the electroplating baths in amounts of 0.1 g/L to 200 g/L.

Sources of silver ions include, but are not limited to, silver oxide, silver nitrate, silver sodium thiosulfate, silver cyanide, silver gluconate; silver-amino acid complexes such as silver-cysteine complexes; silver alkyl sulfonates, such as silver methane sulfonate and silver hydantoin and silver succinimide compound complexes. Although silver cyanide may be a source of silver ions, preferably silver and silver alloy electroplating baths are cyanide-free. The sources of silver ions are included in the aqueous baths in amounts of 1 g/L to 150 g/L.

Sources of gold ions include, but are not limited to, gold salts which provide gold (I) ions. Such sources of gold (I) ions include, but are not limited to, alkali gold cyanide compounds such as potassium gold cyanide, sodium gold cyanide, and ammonium gold cyanide, alkali gold thiosulfate compounds such as trisodium gold thiosulfate and tripotassium gold thiosulfate, alkali gold sulfite compounds such as sodium gold sulfite and potassium gold sulfite, ammonium gold sulfite, and gold (I) and gold (III) halides such as gold (I) chloride and gold (III) trichloride. Typically, the alkali gold cyanide compounds are used such as potassium gold cyanide. The amount of gold salts ranges from 1 g/L to 50 g/L.

A wide variety of palladium compounds may be used as a source of palladium ions. Such palladium compounds include, but are not limited to, palladium complex ion compounds with ammonia as the complexing agent. Such compounds include, but are not limited to, dichlorodiammine palladium (II), dinitrodiammine palladium (II), tetrammine palladium (II) chloride, tetrammine palladium (II) sulfate, tetrammine palladium tetrachloropalladate, tetramine palladium carbonate and tetramine palladium hydrogen carbonate. Additional sources of palladium include, but are not limited to, palladium dichloride, palladium dihromide, palladium sulfate, palladium nitrate, palladium monoxide-hydrate, palladium acetates, palladium propionates, palladium oxalates and palladium formates. Palladium compounds are included in the plating compositions is amounts of 10 g/L to 50 g/L.

Water-soluble nickel salts include, but are not limited to, halides, sulfates, sulfites and phosphates. Typically, the nickel halide and sulfate salts are used. Water-soluble nickel salts are included in amounts of 0.1 g/L to 150 g/L.

Water-soluble tin compounds include, but are not limited to salts, such as tin halides, tin sulfates, tin alkane sulfonates and tin alkanol sulfonatcs. When tin halide is used, it is typical that the halide is chloride. The tin compound is typically tin sulfate, tin chloride or tin alkane sulfonate, and more typically tin sulfate or tin methane sulfonate. Tin salts are included in the compositions in amounts of 5 to 100 g/L.

Water-soluble copper salts include without limitation: copper sulfate; copper halides such as copper chloride; copper acetate; copper nitrate; copper fluoroborate; copper alkylsulfonates; copper arylsulfonates; copper sulfamate; and copper gluconate. Exemplary copper alkylsulfonates include copper (C₁-C₆)alkylsulfonate and more typically copper (C₁-C₃)alkylsulfonate. Typically, the copper salt is included in amounts of 10 g/L to 180 g/L of plating composition.

Sources of indium ions include, but are not limited to, indium salts of alkane sulfonic acids and aromatic sulfonic acids, such as methanesulfonic acid, ethanesulfonic acid, butane sulfonic acid, henzenesulfonic acid and toluenesulfonic acid, salts of sulfamic acid, sulfate salts, chloride and bromide salts of indium, nitrate salts, hydroxide salts, indium oxides, fluoroborate salts, indium salts of carboxylic acids, such as citric acid, acetoacetic acid, glyoxylic acid, pyruvic acid, glycolic acid, malonic acid, hydroxamic acid, iminodiacetic acid, salicylic acid, glyceric acid, succinic acid, malic acid, tartaric acid, hydroxybutyric acid, indium salts of amino acids, such as arginine, aspartic acid, asparagine, glutamic acid, glycine, glutamine, leucine, lysine, threonine, isoleucine, and valine. Water-soluble indium salts are included in the compositions in amounts of 5 g/L to 70 g/L.

In addition to the sources of metal ions, the electroplating baths optionally include one or more conventional additives typically included in metal electroplating baths. Such additives may vary depending on the type of metal to be plated. Such additives are well known in the art and the literature. In general, such conventional additives include, but are not limited to, complexing agents and chelating agents for metal ions, suppressors, levelers, stabilizers, antioxidants, grain refiners, buffers to maintain the pII of the electroplating bath, electrolytes, acids, bases, salts of acids and bases, surfactants and dispersing agents. Some minor experimentation may be required to determine the proper amount of an additive to tailor a particular formulation to improve electroplating performance in view of the addition of the carbon black nono-particles to the bath.

In general, the pH of the electroplating baths may range from less than 1 to 14, typically, the pH ranges from 1 to 12, more typically from 3 to 10. The pH depends on the particular metal or metal alloy to be co-deposited with the carbon black nano-particles as well as the other bath components. Conventional inorganic and organic acids and bases may be used to modify the pH.

In addition to conventional surfactants and dispersing agents, the carbon black nano-particle and metal electroplating baths may include one or more surfactants to assist in providing a uniform dispersion of carbon black nano-particles. In general, surfactants may be included in the baths in amounts of 1 g/L to 100 g/L, preferably from 1 g/L to 60 g/L. Such surfactants include, but are not limited to, secondary alcohol ethoxylates, EO/PO copolymers, beta-naphthol ethoxylates, alkyl ether phosphates, also known as alcohol phosphate esters, and alkyldiphenyloxide disulfonates, and surfactants such as cetyltrimethylammonium hydrogensulfate and quaternary polyvinylimidazole. When tin is used as the metal for the composite, fluorocarbon polymers, such as tetrafluoroethylene fluorocarbon polymers, are included in the plating bath. Examples of commercially available surfactants are TERGITOL™ XD EO/PO copolymer, POLYMAX™ PA-31 ethoxylated beta-naphthol, BASOTRONIC™ PVI quaternary polyvinylimidazole, and TEFLON™ tetrafluoroethylene fluorocarbon polymers.

Exemplary alcohol phosphate esters have a general formula:

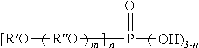

where R′ is hydrogen, C₄-C₂₀ alkyl, phenyl or C₄-C₂₀ alkyl phenyl, R″ is C₂-C₃ alkyl, m is an integer from 0 to 20 and n is an integer from 1 to 3, preferably n is an integer from 1 to 2. When silver is used as the metal for the composite, the silver electroplating bath preferably includes such alcohol phosphate esters.

The compositions of carbon black nano-particles and one or more metal ions may be electroplated onto substrates using conventional electroplating methods. In general, current densities may range from 0.1 ASD and greater. Typically current densities range from 0.1 ASD to 100 ASD. Preferably, current densities range from 0.1 ASD to 10 ASD. When the compositions are electroplated by jet plating, current densities may he from 10 ASD and greater, more typically from 20 ASD to 100 ASD. Composition temperatures during electroplating may range from room temperature to 90° C.

The substrates may be immersed in the electroplating bath, such as in vertical electroplating or by horizontal plating where the substrate is placed on a conveyor and the bath is sprayed onto the substrate. Typically the electroplating bath is agitated during plating usually through pumping the plating solution within the tank or in the case of reel-to-reel plating pumping the solution from the sump tank to the plating cell. Reel-to-reel plating allows for select plating of metal. Various reel-to-reel apparatus arc known by those of skill in the art. The method can plate strips of manufactured products or reels of raw material before they are stamped into parts. The electroplating bath may also be agitated using ultrasound with conventional ultrasound apparatus.

Electroplating times vary depending on the type of metal or metal alloy to be co-deposited with the carbon black nano-particles. The deposited composites are a matrix of metal or metal alloy with carbon black nano-particles substantially uniformly dispersed throughout the metal or metal alloy matrix. Preferably the composites have a matrix of silver, gold, palladium, tin or palladium/nickel alloy. More preferably the composites have a matrix of silver or tin. Most preferably the composites have a silver matrix. Composite thicknesses may vary depending on the metal or metal alloy and the function of the substrate plated. In general, composite thicknesses are at least 0.1 μm, typically from 1 μm to 1000 μm. Preferably, the composite has a thickness of 0.5 μm to 100 μm, more preferably from 1 μm to 50 μm

The composites may be electroplated adjacent conductive surfaces of various types of substrates. Such conductive surfaces include, but are not limited to, copper, copper alloys, nickel, nickel alloys, tin and tin alloys. The composites are electrically conductive and provide a wear resistant deposit with improved durability in comparison to many conventional metal and metal alloy coatings. The composite coatings may be used to replace hard gold coatings of gold/cobalt and gold/nickel which are often used to coat articles which are exposed to rigorous wear cycles or are prone to oxidation due to heat in sliding processes, such as is typical in switches and connectors.

The following examples are included to illustrate the invention but are not intended to limit the scope of the invention.

### EXAMPLE 1 (COMPARATIVE)

An aqueous silver electroplating solution was prepared as shown in the table below.

TABLE 1

| COMPONENT | AMOUNT | |
|---|---|---|
| Silver ions as silver 5,5-dimethyl hydantoin | 40 | g/L |
| 5,5-dimethyl hydantoin | 70 | g/L |
| Sulfamic acid | 35 | g/L |
| Potassium hydroxide | 50 | g/L |
| Graphite (400 nm) | 20 | g/l |

| | |
|---|---|
| pH | 9.5 |

Graphite nano-particles supplied by Nanostructured & Amorphous Materials Inc having an average diameter of 400 nm at a concentration of 20 g/L were mixed with the silver electroplating bath. A clean copper rotating disk cathode was immersed into the solution and was connected to a rectifier. The counter electrode was a silver anode. The temperature of the silver electroplating bath was maintained at 60° C. during silver composite electroplating. The current density was 1 ASD. Electroplating was done until a layer of silver 25 μm thick was deposited on the copper rotating disk. The silver plated disk was removed from the electroplating bath and rinsed with deionized water at room temperature. To ensure that the graphite particles were well dispersed in the plating solution and to facilitate the graphite particle incorporation, a UP400S 400 Watt full amplitude ultrasonic probe, supplied by Hielscher Ultrasonics, Germany, was inserted in the vicinity of the cathode prior to and during the electroplating, at 60% amplitude and 0.5 duty cycle.

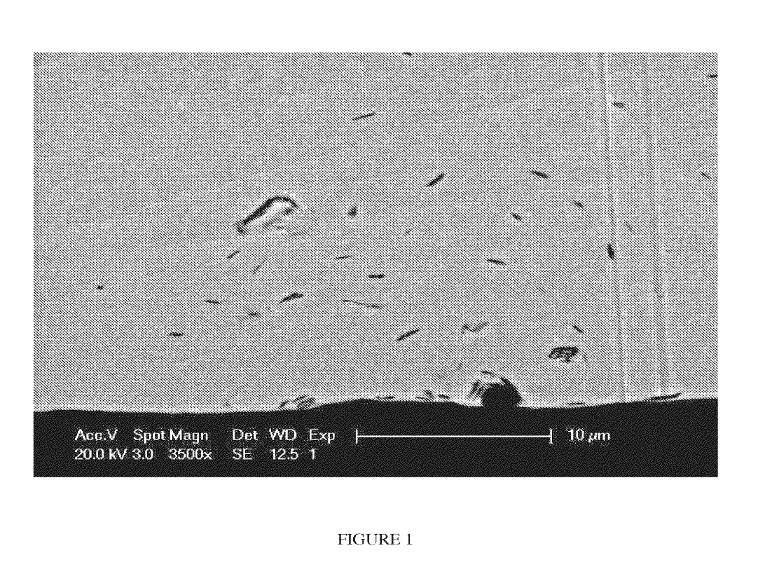

Nano-particle incorporation was investigated by a SEM using a Philips SEM XL-30 microscope on cross sections of the deposits. FIG. 1 is a SEM image (secondary electrons) of a cross-section of the composite layer on the copper substrate at 3500×, obtained using secondary electrons. The dark sections or bands indicate where graphite nano-particles were incorporated into the silver metal matrix. As is evidenced by the SEM the nano-particle incorporation was both sparse and not homogeneous. The nano-particles of graphite agglomerated in the composite.

### EXAMPLE 2

The method of Example 1 was repeated except that 5 g/L of carbon black nano-particles with an average diameter of 25 nm (available from Orion Engineered Carbons) were mixed with the silver electroplating bath in Table 2. The plating parameters were the same as described above.

TABLE 2

| COMPONENT | AMOUNT | |
|---|---|---|
| Silver ions as silver 5,5-dimethyl hydantoin | 40 | g/L |
| 5,5-dimethyl hydantoin | 70 | g/L |
| Sulfamic acid | 35 | g/L |
| Potassium hydroxide | 50 | g/L |
| Carbon Black (25 nm) | 5 | g/l |

| | |
|---|---|
| pH | 9.5 |

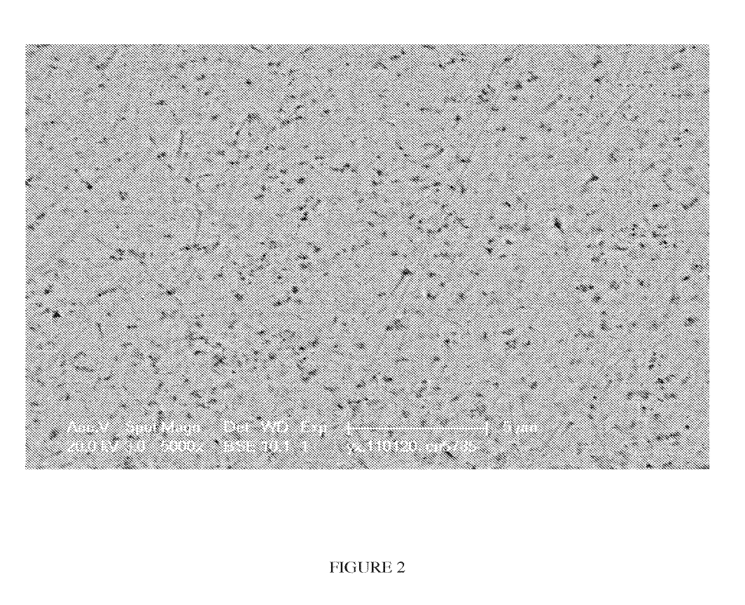

After plating a 25 μm thick composite of silver and carbon black nano-particles on the copper substrate, the substrate was cross-sectioned and examined for nano-particle incorporation in the silver matrix using SEM. FIG. 2 is a 5000×SEM cross-section (back scattered electrons) of the composite. The dark sections indicate areas where the nano-particles of carbon black were incorporated into the silver matrix. As is evident from the SEM in FIG. 2 substantial amounts of nano-particles were incorporated into the silver matrix. The incorporation was homogeneous in contrast to the graphite incorporation of Example 1.

Contact resistance of the composite of silver and carbon black nano-particles was determined and compared to a silver deposit without carbon black nano-particles. Each bath was prepared under the same conditions. The silver and carbon black nano-particle plating bath was the same as in Table 2 above. The silver plating bath was the same as in Table 2 above except that the carbon black nano-particles were excluded from the formulation. A clean copper rotating disk cathode was immersed into each bath and was connected to a rectifier. The counter electrode was a silver anode. The temperature of the baths was maintained at 60° C. during electroplating. The current density was 1 ASD. To ensure that the carbon black particles were well dispersed in the plating solution and to facilitate the carbon black particle incorporation, an ultrasonic probe UP400S was inserted in the vicinity of the cathode prior to and during the electroplating at 60% amplitude and 0.5 duty cycle. Electroplating was done until a layer of silver or silver composite of 25 μm thick was deposited on the copper rotating disks. The plated disks were removed from the electroplating baths and rinsed with deionized water at room temperature.

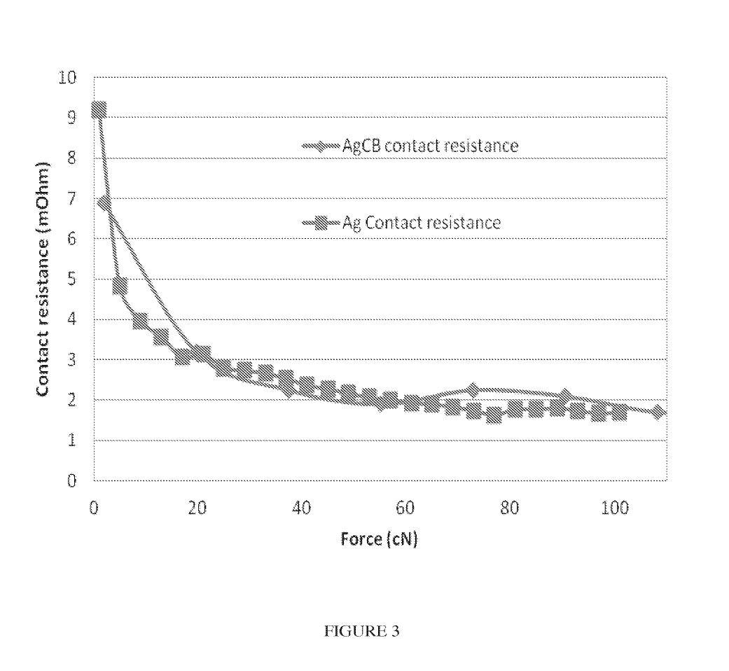

Contact resistance measurements were done using a KOWI 3000 Contact Resistance Tester manufactured by WSK Mess- und Datentechnik GmbH, Germany. FIG. 3 shows the contact resistance in mOhms of both the composite of silver and carbon black nano-particles (AgCB) and the silver (Ag), under varied contact forces in centiNewtons. The results indicated that the contact resistance of the silver and carbon black nano-particles composite remained substantially the same as the silver deposit over the various forces applied.

### EXAMPLE 3

The method of Example 2 was repeated with 50 g/L of carbon black nano-particles. Instead of using ultrasonic disintegration, a surfactant was added into the plating solution to facilitate the particle dispersion. The bath formulation was as disclosed in Table 3. The plating parameters were the same as described above in Example 2.

TABLE 3

| COMPONENT | AMOUNT | |
|---|---|---|
| Silver ions as silver 5,5-dimethyl hydantoin | 40 | g/L |
| 5,5-dimethyl hydantoin | 70 | g/L |
| Sulfamic acid | 35 | g/L |
| Potassium hydroxide | 50 | g/L |
| PHOSPHOLAN ™ PS 331 | 50 | g/l |
| (an alcohol phosphate ester) | | |
| Carbon Black (25 nm) | 50 | g/l |

| | |
|---|---|
| pH | 9.5 |

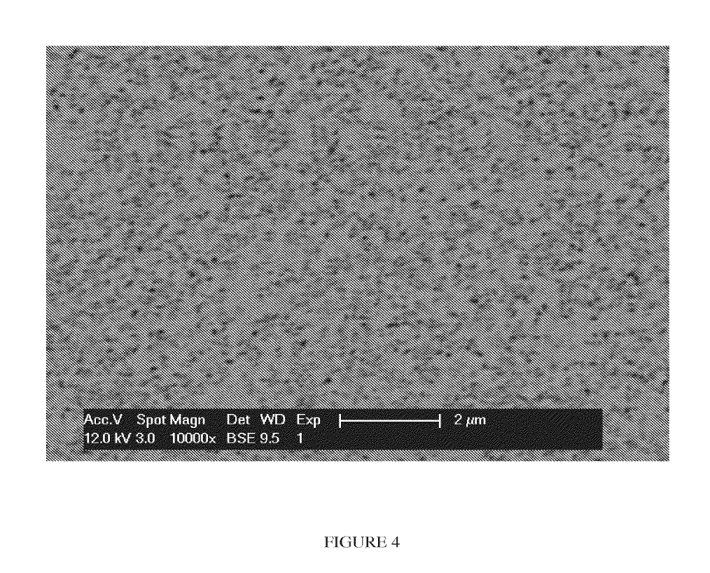

The addition of an alcohol phosphate surfactant to the bath stabilized the carbon black nano-particle dispersion and assisted particle incorporation into the composite. FIG. 4 is a 10,000×SEM cross-section of the composite. The dark sections indicate areas where the nano-particles of carbon black were incorporated into the silver matrix. As is evident from the SEM in FIG. 4 substantial amounts of nano-particles were incorporated into the silver matrix. The incorporation was homogeneous in contrast to the graphite incorporation of Example 1.

1-6. (canceled)

7. A method comprising:
a) providing a composition comprising one or more sources of metal ions and carbon black nano-particles;
b) contacting a substrate with the composition; and
c) electroplating a composite of one or more metals and carbon black nano-particles onto the substrate.

8. The method of claim 7, wherein the carbon black nano-particles range in size from 5 nm to 500 nm.

9. The method of claim 7, wherein metal ions are chosen from silver, gold, palladium, nickel, copper, tin and indium ions.

10. An article comprising a composite comprising one or more metals and carbon black nano-particles dispersed within the one or more metals.

11. The article of claim 10, wherein a thickness of the composite is at least 0.1 μm.
